(19) United States
(12) Patent Application Publication
(10) Pub. No.: US 2014/0325861 A1
(43) Pub. Date: Nov. 6, 2014

(54) OIL INSPECTION DEVICE FOR WORK VEHICLE

(71) Applicant: KOMATSU LTD., Tokyo (JP)

(72) Inventors: Shunji Doi, Hirakata-shi (JP); Kazuma Sakai, Hirakata-shi (JP)

(21) Appl. No.: 14/115,670

(22) PCT Filed: Dec. 26, 2012
(86) PCT No.: PCT/JP2012/083605

§ 371 Date: Nov. 5, 2013

(30) Foreign Application Priority Data
Nov. 16, 2012 (JP) 2012-252654

(51) Int. Cl. G01F 23/04; F01M 11/12; F16N 29/00

(52) U.S. Cl. CPC G01F 23/04; F16N 29/00; F01M 11/12
USPC 33/713

(57) ABSTRACT

An oil inspection device for a work vehicle includes a conduit pipe, a projecting pipe, and an oil inspection tube. A dipstick is used to check the lubricating oil level in the oil inspection device. The conduit pipe has an oil inspection component where oil is checked and conducts the lubricating oil from a reservoir space to the oil inspection component, the reservoir space holding the lubricating oil. The projecting pipe is provided to the conduit pipe and faces upward from the oil inspection component. The oil inspection tube has a connector with a hexagonal prism shape. The connector is removably connected to the projecting pipe and disposed on an outside of the projecting pipe. The oil inspection tube is configured to have the dipstick inserted.

### CROSS-REFERENCE TO RELATED APPLICATIONS

This application is a U.S. National stage application of International Application No. PCT/JP2012/083605, filed on Dec. 26, 2012. This U.S. National stage application claims priority under 35 U.S.C. §119(a) to Japanese Patent Application No. 2012-252654, filed in Japan on Nov. 16, 2012, the entire contents of which are hereby incorporated herein by reference.

### BACKGROUND

1. Field of the Invention

The present invention relates to an oil inspection device for a work vehicle.

2. Background Information

A work vehicle such as a hydraulic excavator is provided with an upper revolving unit having a work implement or the like, and a lower traveling unit having crawlers. In the case of a hydraulic excavator, the work implement is constituted by a boom, an arm, a bucket, or the like.

Swing machinery is provided to make the upper revolving unit revolve with respect to the lower traveling unit. Meanwhile, a swing circle is provided to the lower traveling unit. The swing machinery is provided with an output gear, a brake, a deceleration unit, or the like for decelerating the rotational drive force from the swing motor, and the output gear meshes with teeth provided on the inside or outside of the swing circle. The rotational drive force of the swing motor is transmitted to the output gear, and the swing machinery rotates on the inside or outside of the swing circle, the result being that the upper revolving unit revolves with respect to the lower traveling unit.

Here, since a mechanical coupler, a brake, or the like is provided on the inside of the swing machinery, lubricating oil is contained therein to reduce mechanical friction. An oil inspection device is provided for checking whether this lubricating oil is at the proper level. An example of a conventional oil inspection device is discussed in Japanese Laid-Open Utility Model Application H1-100997.

Meanwhile, oil inspection devices with the configuration shown in FIG. 8 are also used. FIG. 8 is a cross section of a conventional oil inspection device for a work vehicle. As shown in FIG. 8, a conventional oil inspection device for a work vehicle comprises a conduit pipe 101 that extends horizontally from a swing machinery main body 100 side, a projecting pipe 102 provided projecting upward from the conduit pipe 101, and an oil inspection tube 103 connected with the projecting pipe 102 and provided facing upward from the projecting pipe 102. A dipstick 104 is disposed on the inside of the oil inspection tube 103, and whether or not the lubricating oil is at the proper level is checked by looking at the height of the lubricating oil adhering to the tip of the dipstick 104.

With the oil inspection device shown in FIG. 8, the oil inspection tube 103 has a tube component 123 into which the dipstick 104 is inserted, and a connector 113 provided on the lower side of the tube component 123. The oil inspection tube 103 is removably connected to the projecting pipe 102 at the connector 113 to allow maintenance and so forth. More specifically, female threads are machined on the inside of the projecting pipe 102, male threads are machined on the outside of the lower part 113a of the connector 113, and the projecting pipe 102 and the connector 113 are thereby joined and connected. An O-ring 105 is disposed between the inside of the upper end portion of the projecting pipe 102 and the outside of the lower part 113a of the connector 113. An O-ring groove 113b is formed in the upper end of the lower part 113a of the connector 113 in order to install the O-ring 105, and a contact face 102a that presses on the O-ring 105 is formed on the inside of the upper end part of the projecting pipe 102.

The upper part 113c of the connector 113 is in the form of a hexagonal prism so that a hex wrench or the like can be used to easily remove the oil inspection tube 103 from the projecting pipe 102.

However, the following problems were encountered with the above-mentioned conventional oil inspection device for a work vehicle, and particularly a large work vehicle.

Specifically, many of the parts on a large work vehicle are produced in extremely small quantities. With the oil inspection device for a work vehicle shown in FIG. 8, the connector 113 and the conduit pipe 101 are produced integrally by milling. In the production of the connector 113, the hexagonal prism-shaped member 1130 shown in FIG. 9a is used, for example. A through-hole 1130a to which the tube component 123 is attached is formed in the height direction in this hexagonal prism-shaped member 1130. The lower part of this hexagonal prism-shaped member 1130 is milled into a hexagonal prism shape, and the lower part 113a of the connector 113 must be formed as shown in FIG. 9b. The yield is therefore low.

With the conduit pipe 50, the projecting pipe 102 has a large diameter and sticks out, and this also results in a lower yield.

It is an object of the present invention to provide an oil inspection device for a work vehicle that affords a good yield by taking into account the problems encountered with a conventional oil inspection device for a work vehicle.

The oil inspection device for a work vehicle pertaining to the first aspect of the invention is an oil inspection device for a work vehicle in which a dipstick is used to check the lubricating oil level, comprising a conduit pipe, a projecting pipe, and an oil inspection tube. The conduit pipe has an oil inspection component where oil is checked, and conducts the lubricating oil from a reservoir space in which the lubricating oil is held to the oil inspection component. The projecting pipe is provided to the conduit pipe facing upward from the oil inspection component. The oil inspection tube is connected to the projecting pipe, and the dipstick is inserted therein. The oil inspection tube has a connector that is removably connected to the projecting pipe, and the connector has a hexagonal prism shape and is disposed on the outside of the projecting pipe.

Since a work vehicle requires maintenance, etc., the connection between the projecting pipe provided to the conduit pipe facing upward from the oil inspection component, and the connector of the oil inspection tube into which is inserted the dipstick whose tip is disposed in the oil inspection component, is configured to allow removal. The connector is formed in the external shape of a hexagonal prism so that this connection can be easily removed with a hex wrench or the like.

Connection between the projecting pipe and the oil inspection tube is accomplished by disposing the connector of the oil inspection tube on the outside of the projecting pipe.

This allows the projecting pipe and the oil inspection tube to be connected even though the external shape of the connector is hexagonal. Specifically, the connector can be produced at a high yield by milling off part of the hexagonal external shape in order to produce a connector that is disposed on the inside of the projecting pipe as in the past. Also, the conduit pipe can be produced at a high yield since the projecting pipe can be smaller in diameter than in the past.

The oil inspection device for a work vehicle pertaining to the second aspect of the invention further comprises a seal member provided between the projecting pipe and the connector.

Here, disposing the seal member between the projecting pipe and the connector prevents the leakage of the lubricating oil from between the projecting pipe and the connector in a state in which the projecting pipe and the connector have been connected. This improves the reliability of the lubricating oil sealing performance.

The oil inspection device for a work vehicle pertaining to the third aspect of the invention is such that a groove in which a seal member is disposed is formed in the lower end portion on the outside of the projecting pipe.

Here, the groove is formed in the lower end portion on the outside of the projecting pipe, and the seal member is disposed in this groove. When the projecting pipe and the connector are connected, the projecting pipe is inserted inside the connector in a state in which the seal member has been disposed in the groove, for example. This reduces shifting of the seal member position when the connector is being attached to the projecting pipe, etc., and allows the position of the O-ring or other such seal member to remain stable, so reliability of the sealing performance can be improved.

The oil inspection device for a work vehicle pertaining to the fourth aspect of the invention is such that a contact face where the seal member is pressed against the projecting pipe and the conduit pipe is formed at the lower end of the connector.

Here, the contact face is formed at the lower end of the connector, and when the projecting pipe and the connector have been connected, this contact face presses the O-ring or other such seal member against the projecting pipe and the conduit pipe. Since the seal member can be pressed against the projecting pipe and the conduit pipe, the reliability of sealing performance can be further enhanced.

The present invention provides an oil inspection device for a work vehicle with which a high yield is obtained.

### BRIEF DESCRIPTION OF DRAWINGS

FIG. 1 is a front view of the outer configuration of the swing machinery for a work vehicle pertaining to an embodiment of the present invention;

FIG. 2 is a front view of the internal configuration of the swing machinery for a work vehicle in FIG. 1;

FIG. 3 is an oblique view of the outer configuration of the oil inspection device of the swing machinery for a work vehicle in FIG. 2;

FIG. 4 is an oblique view of the outer configuration of the oil inspection device of the swing machinery for a work vehicle in FIG. 2;

FIG. 5a shows the internal configuration of the oil inspection device of the swing machinery for a work vehicle in FIG. 2, and FIG. 5b shows the tip of the dipstick in FIG. 5a;

FIG. 6 shows the internal configuration of the oil inspection device of the swing machinery for a work vehicle in FIG. 2;

FIG. 7 is a detail view of the internal configuration of the oil inspection device of the swing machinery for a work vehicle in FIG. 2;

FIG. 8 is a detail view of the internal configuration of the oil inspection device of conventional swing machinery for a work vehicle; and

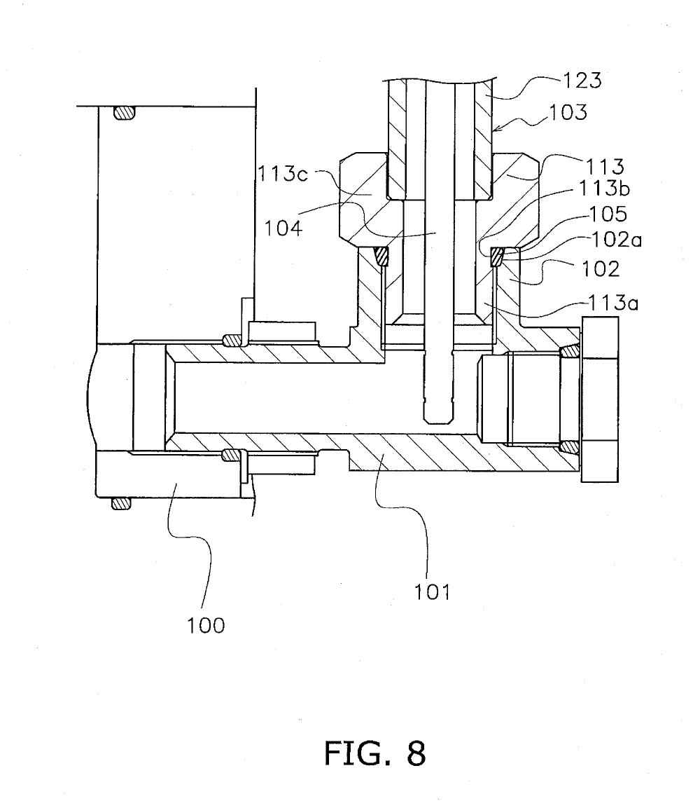

FIG. 9a is an oblique view of a member for producing a connector, and FIG. 9b is an oblique view of a conventional connector.

### DETAILED DESCRIPTION OF EMBODIMENT(S)

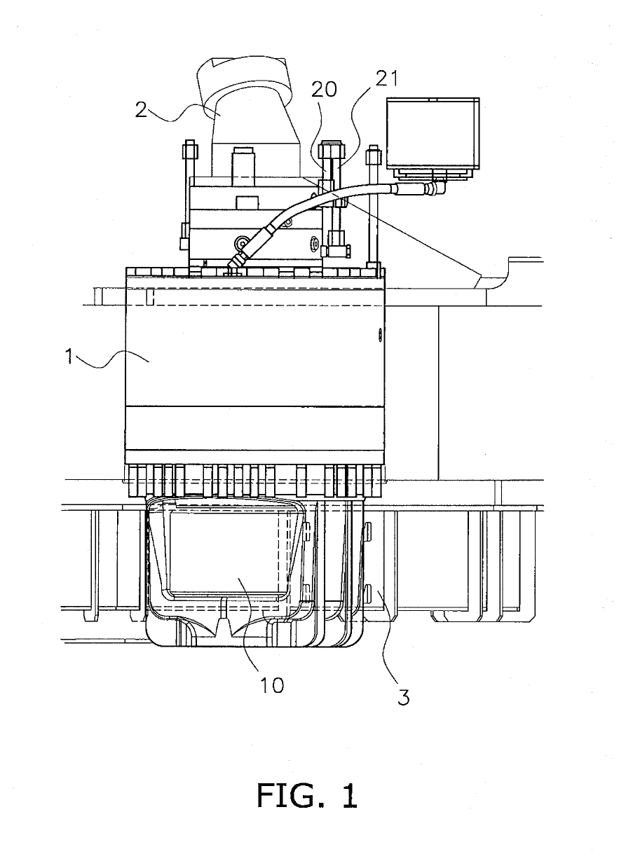

The oil inspection device for a work vehicle pertaining to an embodiment of the present invention will now be described through reference to FIGS. 1 to 7.

A work vehicle such as a hydraulic excavator comprises a lower traveling unit having crawlers provided on the left and right ends in the travel direction, and an upper revolving unit having a work implement or the like.

Swing machinery 1 is provided to the upper revolving unit in order to make the upper revolving unit revolve with respect to the lower traveling unit. FIG. 1 is a side view of the swing machinery 1 in Embodiment 1. As shown in FIG. 1, a motor component 2 in which a swing motor is installed is provided to the upper part of the swing machinery 1. The lower part of the swing machinery 1 is equipped with an output pinion 10 that outputs the rotation produced by the swing motor. A swing circle 3 having teeth around its outer periphery is provided to the lower traveling unit, and the output pinion 10 meshes with the swing circle 3. The rotation of the swing motor is decelerated by a deceleration mechanism inside the swing machinery 1, and transmitted to the output pinion 10, causing the output pinion 10 to rotate. This rotation causes the swing machinery 1 to rotate around the outside of the swing circle 3.

### Structure of Swing Machinery 1

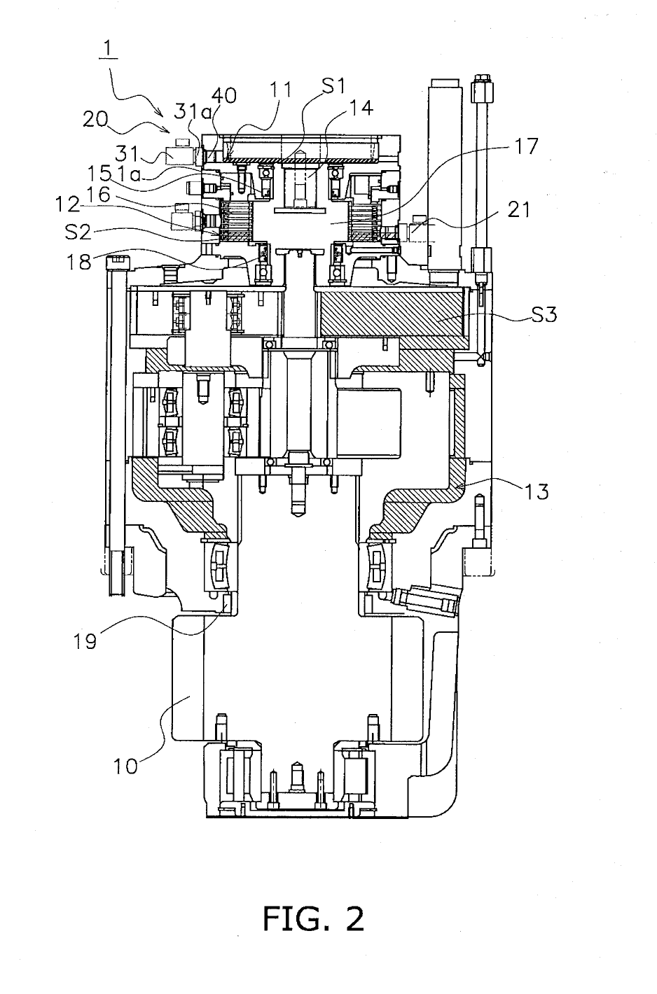

FIG. 2 is a cross section of the main components of the swing machinery 1. As indicated by the hatched parts in FIG. 2, the swing machinery 1 is provided with a first reservoir space 11, a second reservoir space 12, and a third reservoir space 13 in which lubricating oil is held, from the upper part to the lower part. In FIG. 2, the lubricating oil held in the first reservoir space 11 is indicated by the hatching S1, the lubricating oil held in the second reservoir space 12 is indicated by the hatching S2, and the lubricating oil held in the third reservoir space 13 is indicated by the hatching S3. In the first reservoir space 11, the swing motor provided to the motor component 2 is mechanically coupled with a spline shaft 14 of the swing machinery 1. A seal member 15 is provided to the lower part inside the first reservoir space 11, and the seal member 15 holds the lubricating oil inside the first reservoir space 11.

A brake component 16 is provided to the second reservoir space 12 on the lower side of the first reservoir space 11. This brake component 16 is made up of brake disks and brake plates, etc. Either the brake disks or the brake plates mesh with a shaft 17 linked to the spline shaft 14, and the other ones mesh with the inner wall of the second reservoir space 12, so that the brake disks and the brake plates are pressed from above, which halts the rotation of the shaft 17. A seal component 18 is also provided to the lower part of the second reservoir space 12, and this seal component 18 prevents the lubricating oil from leaking out from the bottom of the second reservoir space 12.

A deceleration mechanism or the like is provided to the third reservoir space 13 on the lower side of the second reservoir space 12, and a seal component 19 is provided to the lower part of the third reservoir space 13, just as with the first reservoir space 11 and the second reservoir space 12.

As shown in FIGS. 1 and 2, an oil inspection device 20 for detecting the amount of lubricating oil held in the first reservoir space 11 (hatching S1), and an oil inspection device 21 for detecting the amount of lubricating oil held in the second reservoir space 12 (hatching S2) are provided to the swing machinery 1 in Embodiment 1. FIG. 2 shows only part of the oil inspection devices 20 and 21. An oil inspection device is also provided to the third reservoir space 13, although it is not described in this Specification.

### Structure of Oil Inspection Devices 20 and 21

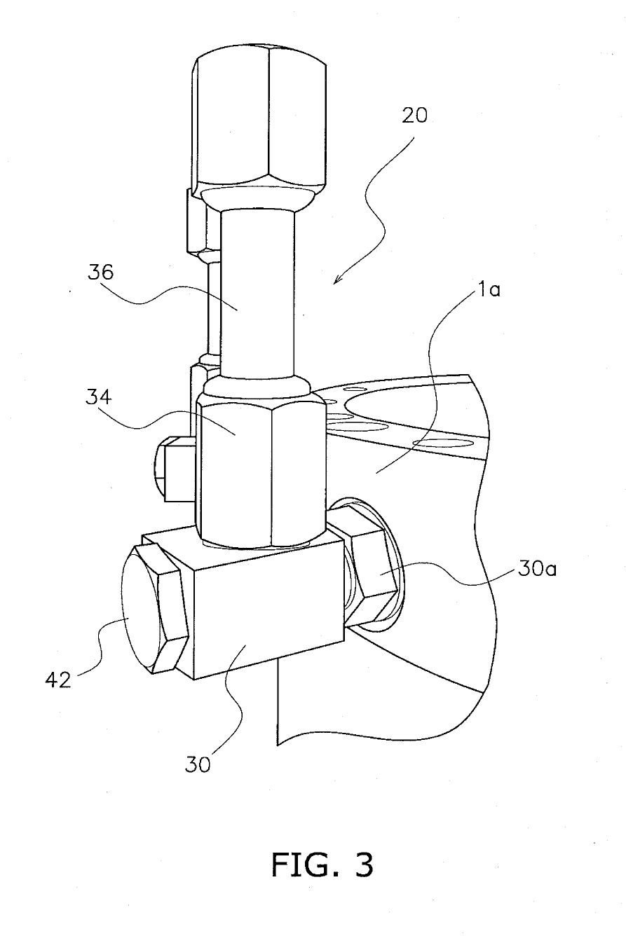

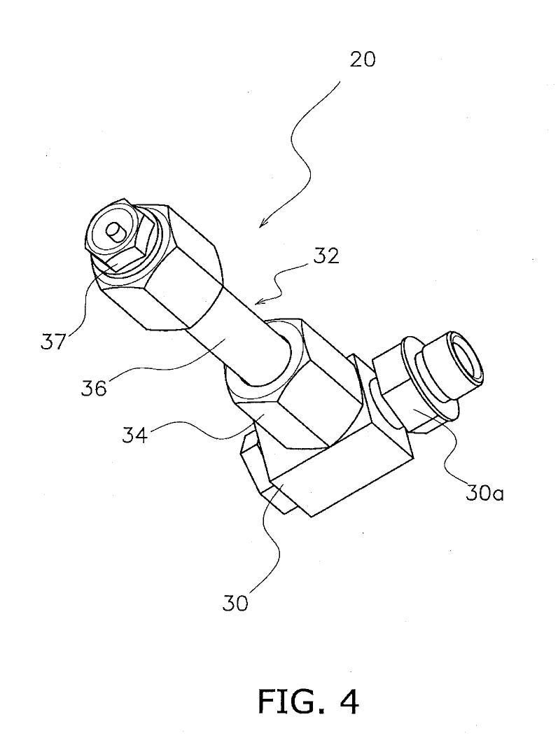

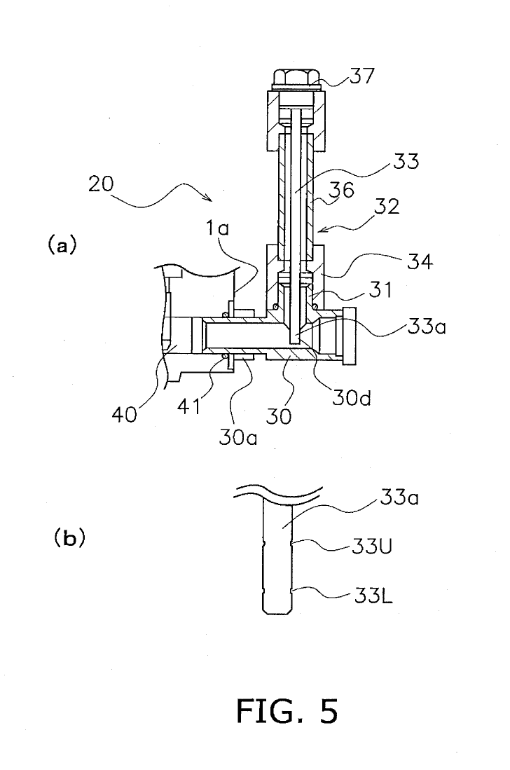

Next, the structure of the oil inspection devices 20 and 21 will be described. FIGS. 3 and 4 are oblique views of the oil inspection device 20. FIG. 3 shows the state when the oil inspection device 20 has been attached to the outer wall 1a of the swing machinery 1. FIG. 5a is a cross section of the oil inspection device 20.

As shown in FIGS. 3 and 5a, the oil inspection device 20 comprises a conduit pipe 30 provided projecting horizontally from the outer wall 1a of the swing machinery 1, a projecting pipe 31 provided projecting upward from the conduit pipe 30, and an oil inspection tube 32 connected to the projecting pipe 31. A dipstick 33 is disposed along the oil inspection tube 32, inside the oil inspection tube 32. As shown in FIG. 5a, the dipstick 33 has an oil inspection area 33a at its tip, and when the dipstick 33 has been inserted into the oil inspection tube 32, the oil inspection area 33a is disposed at an oil inspection component 30d inside the conduit pipe 30. FIG. 5b shows the oil inspection area 33a of the oil inspection tube 32. A concave component 33L for indicating the lower limit level of the contained amount of lubricating oil is formed at the oil inspection area 33a, and a concave component 33U for indicating the upper limit level of the contained amount of lubricating oil is formed on the upper side of this. If it is determined that the height of the contained amount of lubricating oil is in between the concave component 33L and the concave component 33U, it can be concluded that the proper amount of lubricating oil is contained.

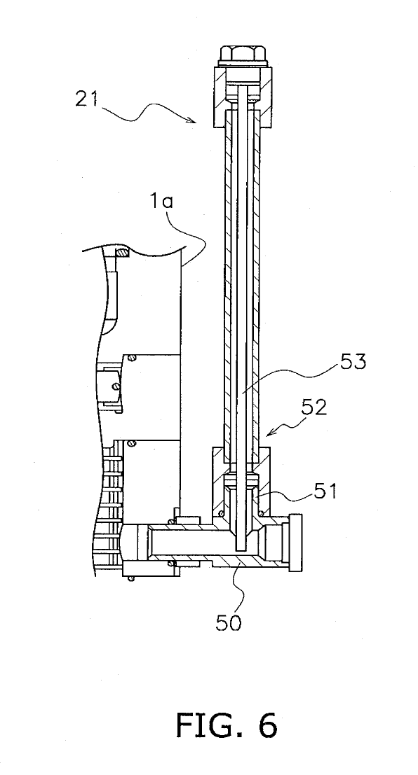

FIG. 6 is a cross section of the oil inspection device 21. As shown in FIG. 6, the oil inspection device 21 differs from the oil inspection device 20 in the dimensions of its various components and so forth, but has basically the same configuration, and is similar to the oil inspection device 20 in that it comprises a conduit pipe 50 projecting horizontally from the outer wall 1a of the swing machinery 1, a projecting pipe 51 provided projecting upward from the conduit pipe 50, and an oil inspection tube 52 connected to the projecting pipe 51. A dipstick 53 for checking the lubricating oil level is provided on the inside of the oil inspection tube 52.

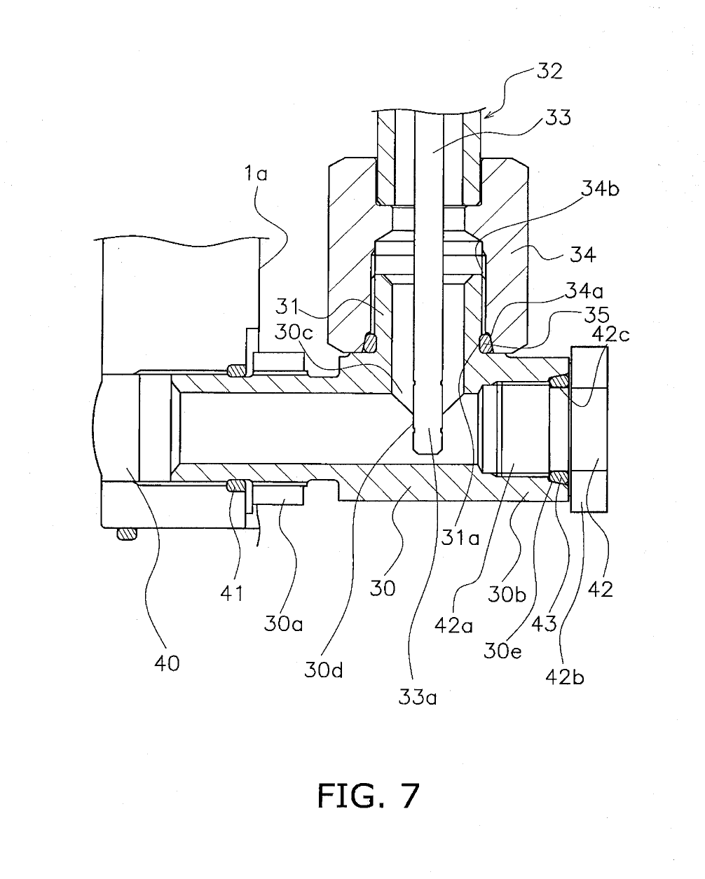

Next, the configuration of the oil inspection device will be described in detail, but since the basic configurations of the oil inspection devices 20 and 21 are the same as mentioned above, just the oil inspection device 20 will be described here. FIG. 7 is a cross section of the main components of the oil inspection device 20.

### Structure of Conduit Pipe 30

As shown in FIGS. 1, 5a, and 7, the conduit pipe 30 is formed so that it projects horizontally from the outer wall 1a, and conducts the lubricating oil in the first reservoir space 11 to the oil inspection component 30d. The conduit pipe 30 is removably connected to a lead-in path 40 formed horizontally from the first reservoir space 11 of the swing machinery 1. Specifically, threads are machined on the outside of the conduit pipe 30 and the inside of the lead-in path 40, and the conduit pipe 30 and the lead-in path 40 are connected by being engaged with each other. Also, a hexagonal portion 30a for attaching and removing the conduit pipe 30 to and from the lead-in path 40 with a hex wrench or the like is formed in the portion of the conduit pipe 30 adjacent to the outer wall 1a. Also, an O-ring 41 is provided as a seal member so that the lubricating oil will not leak out from the joint between the conduit pipe 30 and the lead-in path 40. A groove is formed in the outer wall of the conduit pipe 30 and in the portion of the lead-in path 40 near the outer wall 1a, and O-rings are disposed in these grooves.

A cap 42 is provided to the distal end 30b (in the horizontal direction) of the conduit pipe 30. Threads are machined into the inside of this distal end 30b and the outside of an insertion component 42a of the cap 42, and the distal end 30b and the insertion component 42a are engaged with each other. A contact face 30e is formed on the inside of the distal end 30b, and a groove 42c is formed on the outside of the insertion component 42a. An O-ring 43 disposed in the groove 42c is pressed by the contact face 30e against the cap 42, which seals the distal end of the conduit pipe 30. The portion 42b of the cap 42 that is exposed to the outside (the portion excluding the insertion component 42a) is formed in a hexagonal shape, so that the cap 42 can be removed from the conduit pipe 30 with a hex wrench or the like.

### Structure of Projecting Pipe 31

An opening 30c is formed on the upper side of the oil inspection component 30d of the conduit pipe 30, and the projecting pipe 31 is provided above this opening 30c. In this embodiment, the conduit pipe 30 and the projecting pipe 31 are formed by milling from a single member. As shown in FIG. 7, an O-ring groove 31a for installing an O-ring 35 is formed in the outer face at the lower end of the projecting pipe 31.

### Structure of Oil Inspection Tube 32

As shown in FIG. 5a, the oil inspection tube 32 is provided facing upward from the projecting pipe 31. The oil inspection tube 32 has a tube component 36 into which the dipstick 33 is inserted, a cap 37 provided openably and closeably at the upper end of the tube component 36, and a connector 34 that is provided on the lower side of the tube component 36 and is connected to the projecting pipe 31. When the cap 37 is opened, the dipstick 33 can be taken out of the tube component 36, or the dipstick 33 can be inserted into the tube component 36.

As shown in FIG. 7, the connector 34 is disposed on the outside of the projecting pipe 31, and is a member with a substantially hexagonal shape as shown in FIG. 4. Male threads are machined on the outside of the projecting pipe 31, and female threads are machined on the inside of the connector 34. The O-ring 35 is installed between the projecting pipe 31 and the connector 34. A contact face 34a for pressing on the O-ring 35 is formed at the lower part on the inside of the connector 34, and as mentioned above, the O-ring groove 31a is formed in the lower part on the outside of the projecting pipe 31. This contact face 34a is formed so that the inside diameter of the connector 34 increases from the inside toward the outside. The O-ring 35 is pressed on by the contact face 34a, and thereby pressed against the conduit pipe 30 and the projecting pipe 31.

As discussed above regarding FIG. 4, the connector 34 is in the form of a hexagonal prism, and the connector 34 can be removed from the projecting pipe 31 by turning the connector 34 with a hex wrench or the like. As mentioned above, the conduit pipe 30 can also be removed from the outer wall 1a by turning the hexagonal portion 30a with a hex wrench or the like.

Thus, the oil inspection devices 20 and 21 in this embodiment can be taken apart and removed, so the working disassembling and inspecting the swing machinery 1 during maintenance of the work vehicle, etc., can be carried out more easily.

### Oil Inspection Work

When oil inspection work is performed, the cap 37 is removed from the tube component 36, and the dipstick 33 is pulled out of the oil inspection tube 32. The lubricating oil is then wiped off of the oil inspection area 33a. When the dipstick 33 is then stuck back into the oil inspection tube 32, lubricating oil adheres to the oil inspection area 33a of the dipstick 33. The dipstick 33 is pulled out once more, and it can be concluded that there is the proper amount of oil if the lubricating oil adhesion line is between the concave component 33L and the concave component 33U. If the lubricating oil adhesion line is below the concave component 33L, that means there is not enough lubricating oil, and if the adhesion line is above the concave component 33U, that means there is too much oil.

### Production of Connector 34

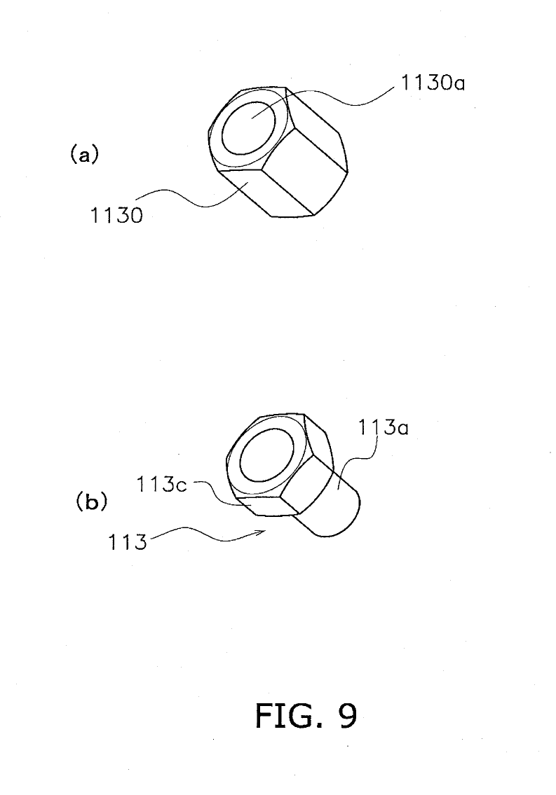

A member 1130 in the shape of a hexagonal prism such as that shown in FIG. 9a is also used in producing the connector 34 of the oil inspection device 20 in this embodiment. The hexagonal member 1130 is milled so that part of the inside diameter of a through-hole 1130a increases, in order to form an insertion component 34b of the projecting pipe 31 on the inside (see FIG. 7). Threads are then machined in the portion with the increased inside diameter. The contact face 34a is formed on the inside at the lower end of the portion with the increased inside diameter, and the connector 34 is formed. The connector 34 and the tube component 36 are connected by welding.

Also, when the projecting pipe 31 and the connector 34 are connected, after the O-ring 35 has been installed in the O-ring groove 31a of the projecting pipe 31, the projecting pipe 31 and the connector 34 are connected by being engaged with each other while one of them is turned.

In this embodiment, since the connector 34 can be produced as above, there is no need to form a cylindrical shape by milling off part of the hexagonal shape as shown in FIG. 9b (conventional example), so the connector 34 can be produced more easily.

Also, in this embodiment, milling is performed for the insertion component 34b instead of machining into a cylindrical shape by milling the outside of the hexagonal shape, but since increasing the inside diameter of the through-hole 1130a (milling to a cylindrical shape) can be easily accomplished, production is easier than in the past.

### Features

(1)

The oil inspection device 20 for a work vehicle in this embodiment is an oil inspection device for using the dipstick 33 to check the lubricating oil level, and as shown in FIG. 4, comprises the conduit pipe 30, the projecting pipe 31, and the oil inspection tube 32. The conduit pipe 30 has the oil inspection component 30d where the oil is checked, and guides lubricating oil from the first reservoir space 11 in which the lubricating oil is held to the oil inspection component 30d. As shown in FIGS. 4 and 7, the projecting pipe 31 is provided to the conduit pipe 30 facing upward from the oil inspection component 30d. The oil inspection tube 32 is connected to the projecting pipe 31, and the dipstick 33 is inserted into it. As shown in FIG. 7, the oil inspection tube 32 has the connector 34 that is removably connected to the projecting pipe 31, and the connector 34 is hexagonal in shape as shown in FIG. 4, and is disposed on the outside of the projecting pipe 31 as shown in FIG. 7. The same applies to the oil inspection device 21 for checking the lubricating oil level inside the second reservoir space 12.

Here, since a work vehicle needs maintenance, etc., the connection between the projecting pipe 31 provided to the conduit pipe 30 facing upward from the oil inspection component 30d, and the connector 34 of the oil inspection tube 32 into which is inserted the dipstick 33 whose tip is disposed in the oil inspection component 30d, is designed to be allow disconnection. The connector 34 is formed in a hexagonal shape to facilitate this connection with a hex wrench or the like.

The connection between the projecting pipe 31 and the oil inspection tube 32 is accomplished by disposing the connector 34 of the oil inspection tube 32 on the outside of the projecting pipe 31.

Consequently, the projecting pipe 31 and the oil inspection tube 32 can be connected while the connector 34 is still in its hexagonal shape. Specifically, there is no need to mill off part of the outside of the hexagonal member 1130 in order to produce the connector 113 disposed on the inside of the projecting pipe 102 as in the past, allowing the connector 34 to be produced more easily. Also, since the projecting pipe 31 is disposed inside the connector 34, the projecting pipe 31 can be smaller in diameter than in the past, allowing the projecting pipe and the conduit pipe to be produced at a higher yield.

(2)

As shown in FIG. 7, the oil inspection device 20 for a work vehicle in this embodiment further comprises the O-ring 35 (an example of a seal member) provided between the projecting pipe 31 and the connector 34.

Here, disposing the O-ring 35 between the projecting pipe 31 and the connector 34 prevents the lubricating oil from leaking out from between the projecting pipe 31 and the connector 34 in a state in which the projecting pipe 31 and the connector 34 have been connected. This improves the reliability of lubricating oil sealing.

(3)

As shown in FIG. 7, the oil inspection device 20 for a work vehicle in this embodiment is such that the O-ring groove 31a (an example of a groove) in which the O-ring 35 (an example of a seal member) is installed is formed at the lower end portion on the outside of the projecting pipe 31.

Here, the O-ring groove 31a is formed at the lower end portion on the outside of the projecting pipe 31, and the O-ring 35 is disposed in this O-ring groove 31a. In connecting the projecting pipe 31 and the connector 34, for example, the projecting pipe 31 is inserted inside the connector 34 in a state in which the O-ring 35 has been disposed in the O-ring groove 31a.

This reduces misalignment of the O-ring 35 in attaching the connector 34 to the projecting pipe 31, etc., and since the sealing position of the O-ring can be stabilized, the reliability of sealing performance can be improved.

(4)

As shown in FIG. 7, the oil inspection device 20 for a work vehicle in this embodiment is such that the contact face 34a that presses the O-ring 35 against the projecting pipe 31 and the conduit pipe 30 is formed at the lower end of the connector 34.

Here, the contact face 34a is formed at the lower end of the connector 34, and when the projecting pipe 31 and the connector 34 are connected, the O-ring 35 is pressed by the contact face 34a against the projecting pipe 31 and the conduit pipe 30. Because the O-ring 35 is pressed against the projecting pipe 31 and the conduit pipe 30, the reliability of sealing performance can be further improved.

### Other Embodiments

An embodiment of the present invention was described above, but the present invention is not limited to or by the above embodiment, and various modifications are possible without departing from the gist of the invention.

### (A)

In the above embodiment, as shown in FIGS. 5a to 7, the projecting pipes 31 and 51 were provided facing vertically upward from the conduit pipes 30 and 50, but they need not be vertical, and as long as they are at least disposed facing upward, they may be formed obliquely to the vertical direction.

### (B)

In the above embodiment, the oil inspection tubes 32 and 52 were also formed facing vertically upward from the projecting pipes 31 and 51, but this is not the only option, and they may instead be formed obliquely to the vertical direction, for example.

### (C)

In the above embodiment, the distal end portion of the conduit pipe 30 in the horizontal direction was closed off by the cap 42, but a cap need not be provided, and the distal end of the conduit pipe 30 may be in a closed shape. The same applies to the conduit pipe 50. However, provided an openable cap is preferable because it affords easier maintenance.

### (D)

In the above embodiment, the conduit pipe 30 and the projecting pipe 31 were said to be formed by milling from a single member, but the conduit pipe 30 and the projecting pipe 31 may instead be formed from separate members and welded together.

### (E)

In the above embodiment, an example was given of an oil inspection device for the swing machinery of a hydraulic excavator, but the present invention is not limited to this. Nor is it limited to swing machinery, and can be applied to any place where lubricating oil needs to be held, and where the level of this oil needs to be checked. The present invention can also be applied to other work vehicles besides a hydraulic excavator.

### INDUSTRIAL APPLICABILITY

The oil inspection device for a work vehicle of the present invention has the effect of improving the yield, and can therefore be widely applied to oil inspection devices for a variety of work vehicles such as hydraulic excavators.

1. An oil inspection device for a swing machinery of a work vehicle, in which a dipstick is used to check the lubricating oil level, said oil inspection device comprising:
a conduit pipe having an oil inspection component where oil is checked, the conduit pipe conducting the lubricating oil from a reservoir space of the swing machinery to the oil inspection component, the reservoir space holding the lubricating oil therein, the conduit pipe projecting horizontally from the swing machinery;
a projecting pipe provided to the conduit pipe and facing upward from the oil inspection component;
an oil inspection tube having
a tube component configured to have the dipstick inserted therein, and
a connector with a hexagonal prism shape, the connector being removably connected to the projecting pipe and being disposed on an outside of the projecting pipe below the tube component; and
a seal member disposed between the projecting pipe and the connector, the seal member being disposed in a lower end portion on the outside of the projecting pipe.

2. (canceled)

3. The oil inspection device for a work vehicle according to claim 1, wherein
a groove is formed in a lower end portion on the outside of the projecting pipe, and the seal member is disposed in the groove.

4. The oil inspection device for a work vehicle according to claim 3, wherein
a contact face is formed at a lower end of the connector, and the seal member is pressed against the projecting pipe and the conduit pipe at the contact face.
